(19) United States
(12) Patent Application Publication
(10) Pub. No.: US 2008/0118018 A1
(43) Pub. Date: May 22, 2008

(54) Reactor Tube Apparatus

(76) Inventor: Franciscus Johannes Maria Schrauwen, Amsterdam (NL)

Correspondence Address: SHELL OIL COMPANY, P O BOX 2463, HOUSTON, TX, 772522463, US

(21) Appl. No.: 11/792,764

(22) PCT Filed: Dec. 8, 2005
(86) PCT No.: PCT/EP05/56596

§ 371 Date: Oct. 4, 2007

(30) Foreign Application Priority Data
Dec. 10, 2004 (EP) 04106479.1

(51) Int. Cl. G21C 1/01

(52) U.S. Cl. 376/352

(57) ABSTRACT

A reactor tube apparatus for a gas and liquid reactor, particularly for use in a Fischer-Tropsch process is disclosed. The apparatus comprises modified reactor tubes for use with a gas cap. Preferred embodiments of the reactor tubes have a slit or aperture which allows a limited amount of liquid to enter the reactor tube before the liquid level reaches the rim of the reactor tube. Thus liquid enters the reactor tubes more gradually which reduces surges of liquid and provides a more consistent dissipation of heat within the reactor tubes.

This invention relates to a reactor tube apparatus to control the flow of liquid into reactor tubes used for carrying out catalytic processes, particularly but not exclusively for a multitube reactor for use in a Fischer-Tropsch process.

A multitube reactor comprises a vessel with a plurality of open-ended reactor tubes arranged therein. The tubes are arranged in parallel with he central reactor axis. The upper ends of the reactor tubes extend through an upper tube plate and/or through the bottom of a horizontal tray arranged above the upper tube plate. The upper ends of the reactor tubes are in fluid communication with a fluid inlet chamber. The fluid inlet chamber is defined between the upper tube plate or the bottom of the tray, and the dome of the vessel. Liquid and gas supply means are provided for supplying liquid and gas to the fluid inlet chamber.

The lower ends of the reactor tubes are fixed to a lower tube plate and are in fluid communication with an effluent collecting chamber below the lower tube plate. The effluent collecting chamber has one or more effluent outlets.

During normal operation the reactor tubes are filled with catalyst particles. To convert for example synthesis gas into hydrocarbons, synthesis gas is supplied through the fluid inlet chamber into the upper ends of the reactor tubes and passed through the reactor tubes. Effluents leaving the lower ends of the reactor tubes are collected in the effluent collecting chamber and removed from the effluent collecting chamber through the effluent outlet(s). During normal operation the reactor tubes are in a vertical direction, the two tube sheets are in a horizontal direction.

To improve heat transfer within the catalyst and also to improve heat transfer from the interiors of said tubes to the inner walls of the reactor tubes, a heat transfer liquid is introduced into the fluid inlet chamber. The liquid which is collected on the bottom of a horizontal tray flows into the upper ends of the reactor tubes. Liquid leaving the lower ends of the reactor tubes is collected in the effluent collecting chamber and removed from the effluent collecting chamber through the effluent outlet. The heat transfer liquid may be a recycled product.

The heat of reaction is removed by a secondary heat transfer fluid, such as boiling water, which is passed along the outer surfaces of the reactor tubes.

A commercial multitube reactor for such processes suitably can have a diameter of from 5-9 m and between about 5,000 and 60,000 reactor tubes, the tubes with a diameter of between about 20 mm and about 45 mm. The length of a reactor tube is about 10 to 15 m.

Such a multitube reactor can be used for the catalytic conversion of a gas to liquid or gaseous products depending on reactor conditions, in the presence of a liquid. For example, such a multitube reactor may be used in a Fischer-Tropsch process.

The Fischer Tropsch process can be used for the conversion of hydrocarbonaceous feed stocks into liquid and/or solid hydrocarbons. The feed stock (e.g. natural gas, associated gas and/or coal-bed methane, residual oil fractions, biomass and coal) is converted in a first step into a mixture of hydrogen and carbon monoxide (this mixture is often referred to as synthesis gas or syngas). The synthesis gas is then fed into a reactor where it is converted in a single step over a suitable catalyst at elevated temperature and pressure into paraffinic compounds ranging from methane to high molecular weight modules comprising up to 200 carbon atoms, or, under particular circumstances, even more.

The Fischer Tropsch reaction is very exothermic and temperature sensitive with the result that careful temperature control is required to maintain optimum operation conditions and desired hydrocarbon product selectivity. Indeed, close temperature control and operation throughout the reactor are major objectives.

Due to the size of the reactor and particularly the number or reactor tubes used the upper tube plate is frequently not exactly flat. Consequently the distances between a horizontal plane and the upper ends of the reactor tubes will vary. As a result there may be reactor tubes which, during normal operation, do not receive the liquid. The heat developed in these reactor tubes during the reaction will not be adequately distributed and this will cause local overheating of the catalysts in the reactor tubes.

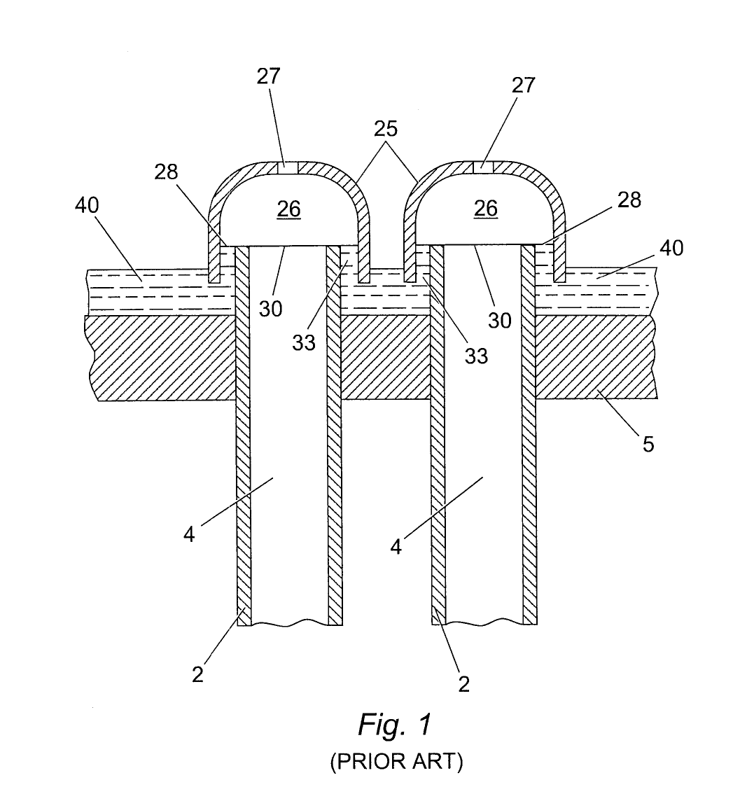

EP 0308034 describes a gas cap for such reactor tubes and one is shown in FIG. 1 herewith, arranged on the upper end 4 of a reactor tube 2. The gas cap 25 comprises an inlet chamber 26 having a gas inlet opening 27, a liquid inlet 28 and an outlet 30 which is in fluid communication with the upper end 4 of the reactor tube 2. The upper ends 4 of reactor tubes 2 do not have fluid communication means other than outlet means 30 of the gas cap 25.

The gas and liquid supply device 25 and upper end of the reactor tube define an annular fluid passage 33 extending from a level in the layer 40 of liquid which is during normal operation present on the tube sheet 5 and the liquid inlet 28 of the inlet chamber 26. The overlap between the gas cap and the upper end of the reactor tube will compensate the differences between the upper tube sheet and a horizontal plane, thus resulting in a situation in which all tubes are able to such up liquid from the layer on top of the upper tube sheet.

These gas caps 25 control the amount of liquid to the various reactor tubes which results in an improved temperature distribution between the different tubes. The gas caps have a specific operating range in that the liquid surrounding the tubes will either be prevented from entering the tubes if the liquid level is not high enough, or will enter the tube substantially over the entire circumference of the reactor tube if the liquid level is high enough.

Although the gas caps described in EP 308034 result in an excellent distribution of gas and liquid over all the tubes in a multitubular reactor, however, it appeared that occasionally pressure fluctuations occurred over the tubes in a multitubular reactor. These pressure fluctuations (an increased pressure drop over the tube) resulted in variations of the gas and liquid distribution over the tubes. As such fluctuation could result in the occurrence of hot spots in the reactor tube, a solution bed to be found to prevent these pressure fluctuations. It has appeared that an amended gas cap resulted in a better stabilisation of the pressure drop over the reactor tube.

The present invention provides a reactor tube apparatus for a gas and liquid reactor comprising:

a reactor tube assembly having an inlet, an outlet and a throughbore running from the inlet to the outlet;

a cap arranged over the inlet of the reactor tube assembly such that a fluid passage is formed to the throughbore of the reactor tube assembly;

wherein the inlet of the reactor tube assembly is shaped to allow ingress of liquid therethrough at more than one vertical height.

The cap is defined in the same way as discussed above. The cap comprises an inlet chamber having a gas inlet opening. The cap further comprises a liquid inlet and a gas/liquid outlet. The gas/liquid outlet is in fluid communication with the inlet chamber and the upper end of the reactor tube. The upper end of the reactor tubes do not have fluid communication means other than the gas/liquid outlet means with the cap. Thus, the gas cap comprises a gas inlet, a separated liquid inlet and a combined gas/liquid outlet. In use, the gas inlet will be above the liquid inlet at the lower end of the gas cap to prevent liquid to enter the inlet chamber via the gas inlet. Usually the distance will be up to 1 meter, suitably between 2 cm and 50 cm, preferably between 5 cm and 30 cm. In general the cap will be an elongated cylinder, which cylinder usually for a large part will encompass the top of the reactor tube. The end of the reactor tube above the tube sheet and/or the bottom of the tray usually has a length of up to 1 m, suitably between 2 cm and 50 cm, preferably between 5 cm and 30 cm. The axis of the cap and the tube end are suitably parallel and usually coincide or overlap. The axis of the cap and the tube end suitably are perpendicular to the tube sheet or tray bottom. The cylindrical opening between the cap and the tube end defines an annular fluid passage extending from the (lower) end of the cap till the top of the tube end. The gas inlet is preferably at the top of the cap. The top end of the reactor tube may have the same diameter as the past of the reactor tube between the two tube sheets, or may have a smaller or larger diameter. In the latter case the cap may have a smaller diameter (than in the case the upper tube en has the same diameter of the remaining part of the tube) or should have a larger diameter. The diameter of the cap is suitably 5 cm larger than the tube end diameter suitably between 2 nm and 2 cm. The gas and liquid reactor as defined in the main claim is especially a multitubular, three phase trickle flow reactor. The distance between the lower end of the gas cap and the upper tube sheet of the tray bottom is suitably up till 10 cm, preferably between 1 and 5 cm.

Typically the reactor tube assembly is, in use, disposed substantially vertically, typically within a reactor.

The inlet may be a rim of the reactor tube assembly which is at an angle of less than 90 degrees to the main axis of the reactor tube assembly. Thus in use, an increasing amount of liquid can proceed into the reactor tube assembly as the level of the liquid rises and liquid can therefore ingress into the inlet at more than one vertical height.

The inlet may be stepped to allow ingress of liquid therethrough at more than one vertical height.

For example a slit or more than one slit may be provided in the tube.

The slit may be, for example, cut into the tube or may be defined by an addition to the end of the tube.

The slit may be rectangular shaped, V-shaped, U-shaped or any other shape.

The reactor tube assembly may comprise a main reactor tube and an extension tube, the extension tube being shaped to allow ingress of liquid into the reactor tube assembly at more than one vertical height.

Thus the extension tube may include the slit. For an extension tube with an inner diameter of 9-10 mm, the slit may be between 0.5 mm-5 mm in width, preferably 1-2 mm in width. The length of the slit may be between 5 and 50 mm, preferably 20-30 mm.

Alternatively or additionally there may be a first inlet and a second inlet and the second inlet may be an aperture in a side of the reactor tube assembly.

The aperture may be between 1-3 mm in diameter.

The invention also provides a multitube reactor suitable for carrying out catalytic processes, comprising a vessel with one or more reactor tube apparatus as herein before described.

Typically the reactor further comprises an upper tube plate shaped to allow collection of liquid thereon in use.

Typically the upper ends of the reactor tube assemblies are fixed to the upper tube plate and are in fluid communication with a fluid inlet chamber above the upper tube plate.

Typically the lower ends of the reactor tube assemblies are fixed to a lower tube plate and are in fluid communication with an effluent collecting chamber below the lower tube plate. Typically an effluent outlet is arranged in the effluent collecting chamber. Often there will be at least a gas outlet and a liquids outlet.

Typically the reactor comprises liquid supply means for supplying liquid to the fluid inlet chamber and gas supply means for supplying gas to the fluid inlet chamber.

The multitube reactor may include a horizontal tray arranged above the upper tube plate, and wherein the reactor tube assemblies pass through the bottom of the horizontal tray. Preferably the extension tube extends through the horizontal tray whilst the main reactor tubes do not extend through the horizontal tray.

The distance between the gas inlet opening and the outlet of the inlet chamber may be in the range of from 0.1 to 3 times the inner diameter of the reactor tube.

The diameter of the gas inlet opening may be in the range of from 1% to 30% (for example 3-7 mm) of the inner diameter of the reactor tube. The inner diameter of the reactor tube is suitably 10-35 mm.

The present invention also provides the use of a reactor tube apparatus as hereinbefore described for a Fischer-Tropsch process.

The present invention also provides the use of a reactor vessel as hereinbefore described for a Fischer-Tropsch process.

The Fischer-Tropsch synthesis is well known to those skilled in the art and involves synthesis of hydrocarbons from a gaseous mixture of hydrogen and carbon monoxide, by contacting that mixture at reaction conditions with a Fischer-Tropsch catalyst.

Products of the Fischer-Tropsch synthesis may range from methane to heavy paraffinic waxes. Preferably, the production of methane is minimised and a substantial portion of the hydrocarbons produced have a carbon chain length of a least 5 carbon atoms. Preferably, the amount of C₅+ hydrocarbons is at least 60% by weight of the total product, more preferably, at least 70% by weight, even more preferably, at least 80% by weight, most preferably at least 85% by weight. Gas phase products such as light hydrocarbons and water may be removed using suitable means known to the person skilled in the art. Alternatively they may all be removed together and separated downstream.

Fischer-Tropsch catalysts are known in the art, and typically include a Group VIII metal component, preferably cobalt, iron and/or ruthenium, more preferably cobalt. Typically, the catalysts comprise a catalyst carrier. The catalyst carrier is preferably porous, such as a porous inorganic refractory oxide, more preferably alumina, silica, titania, zirconia or mixtures thereof.

The optimum amount of catalytically active metal present on the carrier depends inter alia on the specific catalytically active metal. Typically, the amount of cobalt present in the catalyst may range from 1 to 100 parts by weight per 100 parts by weight of carrier material, preferably from 10 to 50 parts by weight per 100 parts by weight of carrier material.

The catalytically active metal may be present in the catalyst together with one or more metal promoters or co-catalysts. The promoters may be present as metals or as the metal oxide, depending upon the particular promoter concerned. Suitable promoters include oxides of metals from Groups IIA, IIIB, IVB, VB, VIB and/or VIIB of the Periodic Table, oxides of the lanthanides and/or the actinides. Preferably, the catalyst comprises at least one of an element in Group IVB, VB and/or VIIB of the Periodic Table, in particular titanium, zirconium, manganese and/or vanadium. As an alternative or in addition to the metal oxide promoter, the catalyst may comprise a metal promoter selected from Groups VIIB and/or VIII of the Periodic Table. Preferred metal promoters include rhenium, platinum and palladium.

A most suitable catalyst comprises cobalt as the catalytically active metal and zirconium as a promoter. Another most suitable catalyst comprises cobalt as the catalytically active metal and manganese and/or vanadium as a promoter.

The promoter, if present in the catalyst, is typically present in an amount of from 0.1 to 60 parts by weight per 100 parts by weight of carrier material. It will however be appreciated that the optimum amount of promoter may vary for the respective elements which act as promoter. If the catalyst comprises cobalt as the catalytically active metal and manganese and/or vanadium as promoter, the cobalt:(manganese+vanadium) atomic ratio is advantageously at least 12:1.

The Fischer-Tropsch synthesis is preferably carried out at a temperature in the range from 125 to 350° C., more preferably 175 to 275° C., most preferably 200 to 260° C. The pressure preferably ranges from 5 to 150 bar abs., more preferably from 5 to 80 bar abs.

Hydrogen and carbon monoxide (synthesis gas) is typically fed to the reactor at a molar ratio in the range from 0.4 to 2.5. Preferably, the hydrogen to carbon monoxide molar ratio is in the range from 1.0 to 2.5.

The gaseous hourly space velocity may very within wide ranges and is typically in the range from 1500 to 10000 Nl/l/h, preferably in the range from 2500 to 7500 Nl/l/h.

In the catalytic conversion process especially more than 75wt % of C₅₊, preferably more than 85 wt % C₅₊ hydrocarbons are formed.

Depending on the catalyst and the conversion conditions, the amount of heavy wax (C₂₀₊) may be up to 60 wt %, sometimes up to 70 wt %, and sometimes even up till 85 wt % of the C₅₊ fraction. The pressure fluctuation mainly occur when the amount of heavy wax (C₂₀₊) is above 40 wt % of the C₅₊ fraction. It is observed that due to the pressure fluctuations the amount of syngas and liquid flowing through the tube will vary, thus resulting in varying amounts of heat transfer and thus to temperature differences.

Preferably a cobalt catalyst is used, a low H₂/CO ratio is used (especially 1.7, or even lower) and a low temperature is used (190-230° C.).

To avoid any coke formation, it is preferred to use an H₂/CO ratio of at least 0.3. It is especially preferred to carry out the Fischer-Tropsch reaction under such conditions that the SF-alpha value, based on the obtained saturated linear C₂₀ hydrocarbon fraction and the obtained saturated linear hydrocarbon C₄₀ fraction, is at least 0.925, preferably at least 0.935, more preferably at least 0.945, even more preferably at least 0.955. Preferably the Fischer-Tropsch hydrocarbons stream comprises at least 35 wt % C₃₀₊, preferably 40 wt %, more preferably 50 wt %. The pressure fluctuation mainly occur when the alpha value is above 0.90.

It will be understood that the skilled person is capable to select the most appropriate conditions for a specific reactor configuration and reaction regime.

The invention will now be described by way of example only with reference to the accompanying drawings, wherein:

FIG. 1 is a cross-sectional view showing two known gas caps and reactor tubes;

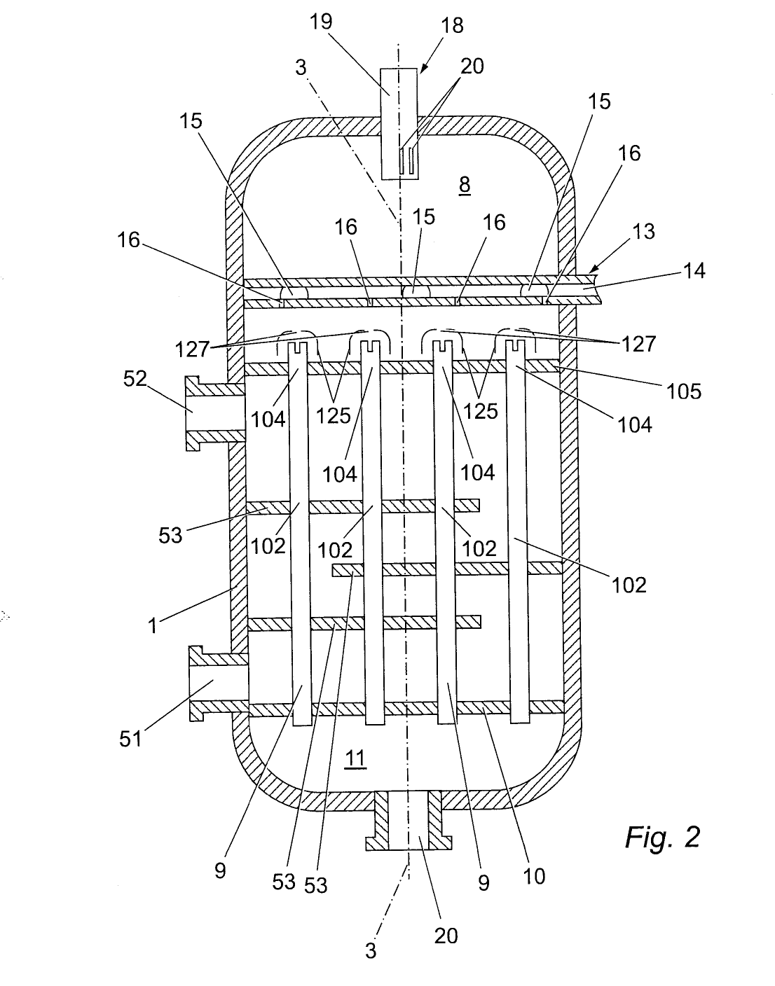

FIG. 2 shows a longitudinal cross-section of a multitube reactor according to one embodiment of the invention;

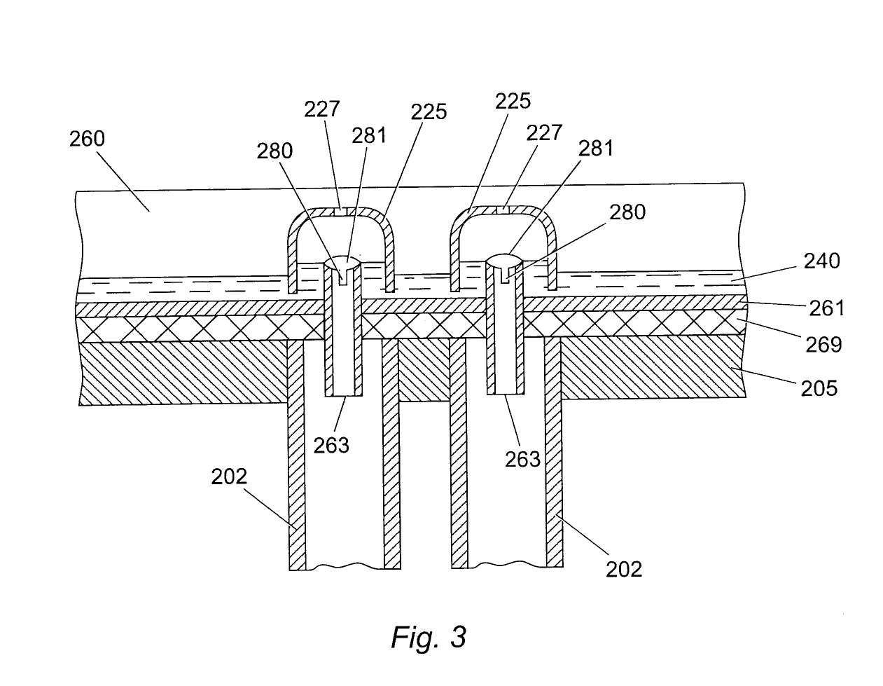

FIG. 3 is a cross-sectional view of two gas caps and reactor tubes according to a further embodiment of the present invention;

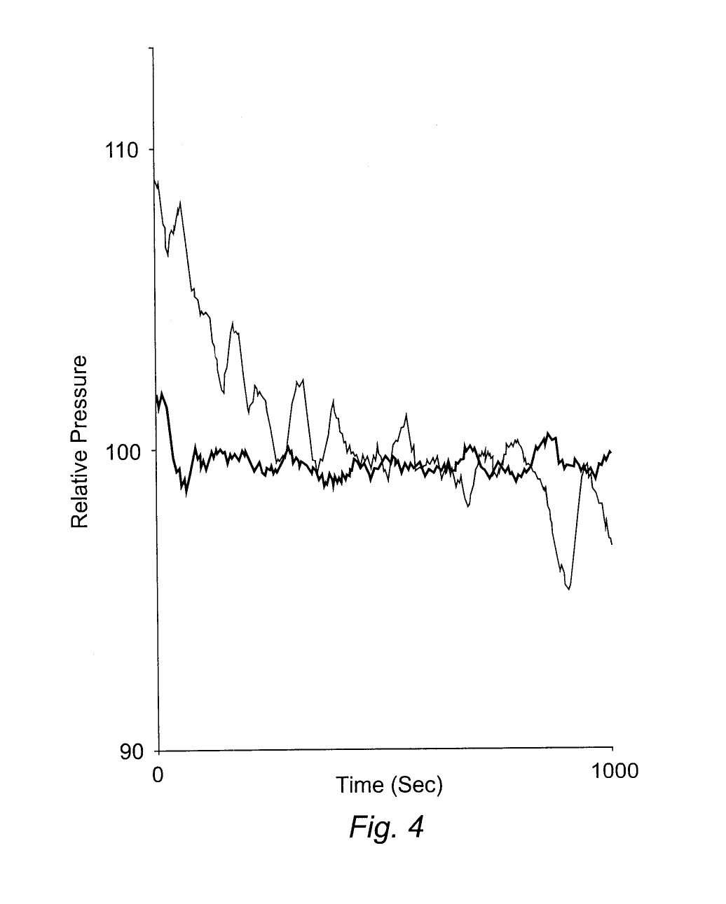

FIG. 4 is a graph showing the relative pressure drop of the FIG. 1 known gas cap and reactor configuration compared with a gas cap and reactor configuration in accordance with one embodiment of the present invention.

Reference is made to FIG. 2 showing a multitube reactor in accordance with the present invention comprising a vessel 1 and a plurality of open-ended reactor tubes 102 arranged in the vessel 1 parallel to its central longitudinal axis 3. The vessel 1 is mounted substantially vertically.

The upper ends 104 of the reactor tubes 102 are fixed to an upper tube plate 105 which is supported by the inner wall of the vessel 1. In the upper end part of the vessel 1, above the upper tube plate 105, there is a fluid inlet chamber 8 which is in fluid communication with the upper end parts 104 of the reactor tubes. The lower end parts 9 of the reactor tubes 102 are fixed to a lower tube plate 10 supported by the inner wall of the vessel 1. In the lower end part of the vessel 1, below the lower tube plate 10, there is an effluent collecting chamber 11 which is in fluid communication with the lower ends 9 of the reactor tubes 102.

The vessel 1 is provided with liquid supply means 13 for supplying liquid to the fluid inlet chamber 8, which liquid supply means 13 comprises a main conduit 14 extending through the wall of the vessel 1 and a plurality of secondary conduits 15 extending perpendicular to the main conduit 14 and being in fluid communication with the main conduit 14. The main conduit 14 and the secondary conduits 15 are provided with outlet openings 16. The vessel 1 is further provided with gas supply means 18 for supplying gas to the fluid inlet chamber 8, in the form of a conduit 19 extending through the wall of the vessel 1 and being provided with slots 20. Alternatively, other gas supply means may be used, for example a conduit may direct the gas onto a deflector plate which, in turn, directs the gas outwardly in order to provides a more uniform distribution of gas to the various reactor tubes.

In the lower part of the vessel 1 there is arranged an effluent outlet 20 communicating with the effluent collecting chamber 11.

As shown in more detail in FIG. 3, the upper end part 104 of each reactor tube 102 is provided with a gas and liquid supply device or ‘gas cap’ 125 arranged in the fluid inlet chamber 8. The gas cap 125 is provided over the upper end 104 of the reactor tube 102 which extends out from the upper tube plate 105 such that an annular space 133 is provided between the gas cap 125 and the upper end 104 of the reactor tube 102. The annular space 133 allowed between the gas cap 125 and the reactor tube 102 allows liquid to enter the gas cap 125 and thereafter proceed into the reactor tube 102 as will be described below.

The gas cap 125 has an orifice 127 which, in use, receives gas. The orifice 127 may be at the top of the gas cap 125 as shown in FIG. 2, or alternatively may be provided in a side of the gas cap 125. An outlet 128 communicates with the bore of the reactor tube 104. Thus liquid accumulated on the tube sheet 105 in use may flow up between the gas cap 125 and the reactor tube 104, gas will flow into the gas cap 125 via the orifice 127 and both gas and liquid can proceed into the reactor tube 104.

A rectangular-shaped weir or slit 180 is provided on the top of the reactor tube 102. Thus the reactor tube 102 has a stepped inlet allowing liquid to proceed into the reactor tubes at two different vertical heights—either through the weir 180 or through the main bore 181. These are spaced apart vertically from one another (as defined by the main longitudinal axis of the reactor tube 103) and the liquid which accumulates on the tube plate 105 in use, rises in the annular space 133 between the gas cap 125 and the top of the reactor tube 104 and can enter the reactor tube 104 via the weir 180 or the main bore 181.

One embodiment of the invention has a weir with a 1 mm width and a height of 25 mm. The distance between the bottom of the weir and the bottom of the tube plate is around 350 mm.

During normal operation, the reactor tubes 102 are filled with catalyst particles (not shown), supported in the reactor tubes 102 by catalyst support means (not shown) arranged in the lower end parts of the reactor tubes 102.

To carry out a process for the catalytic conversion of gas in the presence of a liquid, or the catalytic conversion of a liquid in the presence of gas, gas and liquid are supplied to the gas supply means 18 and the liquid supply means 14, respectively. Liquid is collected on the upper tube plate 105 so that a layer 40 of liquid is formed. Gas flows through the gas inlet openings 127 of the inlet chambers 126, and consequently the pressure in the inlet chambers 126 is below the pressure in the fluid inlet chamber 8. As a result liquid is drawn from the layer 140 through the annular space 133 through the weir 181 and into the reactor tubes 102 filled with catalyst particles and the conversion takes place in the reactor tubes 102. When the liquid enters the reactor tube, a pressure rise results and, if of sufficient magnitude, the level of the liquid in the annular space 133 recedes to below the level of the weir 181. This stops further liquid from entering the reactor tube. If the magnitude of the pressure rise is not great enough to cause the liquid level to recede, the liquid continues up the annular space 133 and proceeds over the rim 130 and into the reactor tube 102. This continues until the corresponding pressure rise, causes the liquid level to recede. By appropriate sizing of the reactor tube 102, gas cap 125 and weir 151, the amount of gas which enters the reactor tube 102 can be kept generally constant.

The weir 181 also serves to reduce the amount of liquid which is suddenly drawn into the reactor tube in the case of a gas-flow surge or spike.

Thus the weir decreases the effect of different reactor tubes 102 affecting each other since they will have a reduced sensitivity to gas feed flow rate changes.

The effluents are collected in the effluent collecting chamber 11, and removed therefrom through effluent outlet 20.

If the conversion is an exothermic reaction the heat of reaction is removed by a cold fluid supplied to the heat-exchange chamber through inlet 51 and removed therefrom through outlet 52. If the conversion is an endothermic reaction additional heat is supplied by a hot fluid supplied to the heat-exchange chamber through inlet 51 and removed therefrom through outlet 52. In addition, the heat-exchange chamber is provided with baffles 53 to guide the fluid passing therethrough.

FIG. 3 shows a further embodiment of a gas-cap 225 and two reactor tube assemblies, each reactor tube assembly comprising a main reactor tube 202 and an extension tube 263. An impermeable layer 261 and base plate 269 are provided over a tube plate 205. The main reactor tubes 202 extend into the tube plate 205 but do not extend through the impermeable layer 261. Rather, each extension tube 263 extends through the impermeable layer 261 and provides for fluid communication between the main reactor tube 202 and the gas cap 227.

A slit or weir 280 is provided in the side of each extension tube 263, towards its upper end. Thus each extension tube 263 has two liquid inlets—the weir 280 and a rim 281 at its top end. The liquid inlets are spaced apart vertically from one another.

In this example, the extension tube 263 has an outer diameter of 11 mm and an inner diameter of 9 mm. the weir 280 extends downwards from the top of the extension tube by 25 mm and the distance between the bottom of the weir 280 and the impermeable layer 261 is around 350 mm. The annular distance between the extension tube 263 and the gas cap 225 is 5 mm whilst the distance between the top of the extension tube 263 and the inlet 227 is 6 mm. The inlet 227 is 3.7 mm in diameter.

In use, liquid accumulates on the impermeable layer 261 and can proceed into the reactor tubes 202 in a similar manner as described for the previous embodiment: liquid is drawn into the gas cap 227, a limited amount can proceed through the weir 280 to the reactor tube 202 and further liquid can proceed over the rim 281 of the extension tube 263, also to the reactor tube 202.

For illustration purposes, the top of the extension tube 263 is shown in perspective in order to show the weir 280.

In an alternative embodiment, the upper ends of the reactor tubes or extension tubes are cut at an acute angle so that the rim of each reactor tube defines a plane which is at an angle of less than 90° to the main axis of the tube. In that way more liquid will enter the inlet of the reactor tube as the liquid rises up the annular space between the end cap and the tube.

In further alternative embodiments the weir 180/280 may be V-shaped, U-shaped or any other shape. An aperture may be provided in the upper end of the reactor tube 104/202 to provide a further liquid inlet for the reactor tube 102/202. A plurality of weirs may be provided, either at the same or at a different height than the weir 180/280. The inlet 181/281 of the reactor tube can be tapered so that liquid enters the reactor tube 102/202 at different vertical heights.

Experiments have been carried out to compare the known reactor tube apparatus with a gas-cap and a reactor tube without a second inlet vertically spaced from the first inlet and a reactor tube apparatus with a gas-cap in accordance with the present invention.

The upper end part of each reactor tube is provided with a gas and gas cap in the form of a cap arranged around the upper end part of the reactor tube closed at its upper end by a plate provided with a gas inlet opening, wherein the width of the annulus between the cap and the upper end part of the reactor tube is 5 mm, the distance between the gas inlet opening and the upper end of the reactor tube is 6 mm, and wherein the diameter of the inlet opening is 3.7 mm.

The lower ends of the reactor tubes debouche into a separation vessel so as to allow independent determination of the gas and liquid velocities through the reactor tubes.

Nitrogen was used to simulate the gas, and dodecane and pentadecane were used to simulate the liquid. This system was pressurised to simulate typical reactor conditions.

FIG. 4 shows the relative pressure drop for the conventional system compared to one embodiment of the present invention (the latter in bold). It can be observed that pressure stabilises quicker for the embodiment in accordance with the present invention and that the pressure fluctuations thereafter are also less than the known configuration.

Improvements and modifications may be made without departing from the scope of the invention.

1. A reactor tube apparatus for a gas and liquid reactor comprising:
a reactor tube assembly having an inlet, an outlet and a throughbore running from the inlet to the outlet;
a cap arranged over the inlet of the reactor tube assembly such that a fluid passage is formed to the throughbore of the reactor tube assembly, the cap comprising an inlet chamber having a gas inlet opening, a liquid inlet and an outlet which is in fluid communication with the upper end of the reactor tube, the upper end of the reactor tube not having fluid communication means other than the outlet of the cap;
wherein the inlet of the reactor tube assembly is shaped to allow ingress of liquid therethrough at more than one vertical height.

2. The reactor tube apparatus as claimed in claim 1, wherein the inlet is a rim of the reactor tube assembly, the rim being disposed at an acute angle to the main axis of the reactor tube assembly to allow ingress of liquid therethrough at more than one vertical height.

3. The reactor tube apparatus as claimed in claim 1, wherein the inlet is a rim of the reactor tube assembly, the rim being stepped to allow ingress of liquid therethrough at more than one vertical height.

4. The reactor tube apparatus as claimed in claim 3, wherein said stepped rim comprises at least one slit in the reactor tube assembly.

5. The reactor tube apparatus as claimed in claim 4, wherein the slit is between 20 mm and 30 mm in length.

6. The reactor tube apparatus as claimed in claim 1, wherein the reactor tube assembly has a first inlet and a second inlet and the second inlet is an aperture in a side of the reactor tube assembly.

7. The reactor tube apparatus as claimed in claim 1, wherein the reactor tube assembly comprises a main reactor tube and an extension tube, the extension tube being the part of the assembly shaped to allow ingress of liquid into the reactor tube assembly at more than one vertical height.

8. (canceled)

9. A multitube reactor suitable for carrying out catalytic processes, comprising a vessel with one or more reactor tube apparatus for a gas and liquid reactor comprising:
a reactor tube assembly having an inlet an outlet and a throughbore running from the inlet to the outlet;
a cap arranged over the inlet of the reactor tube assembly such that a fluid passage is formed to the throughbore of the reactor tube assembly, the cap comprising an inlet chamber having a gas inlet opening, a liquid inlet and an outlet which is in fluid communication with the upper end of the reactor tube, the upper end of the reactor tube not having fluid communication means other than the outlet of the cap;
wherein the inlet of the reactor tube assembly is shaped to allow ingress of liquid therethrough at more than one vertical height.

10. (canceled)

11. A multitube reactor suitable for carrying out catalytic processes, comprising:
a normally substantially vertically extending vessel, a plurality of open-ended reactor tubes arranged in the vessel parallel to its central longitudinal axis of which the upper ends are fixed to an upper tube plate and in fluid communication with a fluid inlet chamber above the upper tube plate and of which the lower ends are fixed to a lower tube plate and in fluid communication with an effluent collecting chamber below the lower tube plate, liquid supply means for supplying liquid to the fluid inlet chamber, gas supply means for supplying gas to the fluid inlet chamber, and an effluent outlet arranged in the effluent collecting chamber, wherein the upper end part of each reactor tube is provided with a gas and liquid supply device, which device comprises an inlet chamber having a gas inlet opening, a liquid inlet and an outlet which is in fluid communication with the upper end part of the reactor tube, and a liquid riser extending between a level in the layer of liquid which is during normal operation present in the fluid inlet chamber and the liquid inlet of the inlet chamber, in which the upper end part of the reactor is shaped to allow ingress of liquid therethrough at more than one vertical height;
wherein the tubes contain a Fischer-Tropsch catalyst.

12. A process for producing liquid hydrocarbons through a Fischer-Tropsch process comprising; passing a synthesis gas through a multitube reactor comprising a normally substantially vertically extending vessel, a plurality of open-ended reactor tubes arranged in the vessel parallel to its central longitudinal axis of which the upper ends are fixed to an upper tube plate and in fluid communication with a fluid inlet chamber above the upper tube plate and of which the lower ends are fixed to a lower tube plate and in fluid communication with an effluent collecting chamber below the lower tube plate, liquid supply means for supplying liquid to the fluid inlet chamber, gas supply means for supplying gas to the fluid inlet chamber, and an effluent outlet arranged in the effluent collecting chamber, wherein the upper end part of each reactor tube is provided with a gas and liquid supply device, which device comprises an inlet chamber having a gas inlet opening, a liquid inlet and an outlet which is in fluid communication with the upper end part of the reactor tube, and a liquid riser extending between a level in the layer of liquid which is during normal operation present in the fluid inlet chamber and the liquid inlet of the inlet chamber, in which the upper end part of the reactor is shaped to allow ingress of liquid therethrough at more than one vertical height.
